(19) United States
(12) Patent Application Publication
(10) Pub. No.: US 2021/0313641 A1
(43) Pub. Date: Oct. 7, 2021

(54) COLLECTOR TERMINAL, BATTERY, AND MANUFACTURING METHOD OF BATTERY

(71) Applicant: TOYOTA JIDOSHA KABUSHIKI KAISHA, Toyota-shi (JP)

(72) Inventor: Toshiki IMABORI, Toyota-shi (JP)

(73) Assignee: TOYOTA JIDOSHA KABUSHIKI KAISHA, Toyota-shi (JP)

(21) Appl. No.: 17/182,520

(22) Filed: Feb. 23, 2021

(30) Foreign Application Priority Data
Apr. 1, 2020 (JP) 2020-065984

(51) Int. Cl. H01M 50/176; H01M 50/533; H01M 10/04; H01M 50/553

(52) U.S. Cl. CPC H01M 50/176; H01M 50/553; H01M 10/049; H01M 50/533

(57) ABSTRACT

A collector terminal that electrically connects an external terminal at least part of which is disposed on an outer side of a battery case and an electrode body accommodated on an inner side of the battery case, includes a base portion that is attached to the external terminal, and a lead portion that extends from the base portion and is joined to the electrode body. A recessed portion is provided at a foot part of the lead portion at a boundary portion between the base portion and the lead portion so as to extend along a width direction orthogonal to an extending direction of the lead portion. A slit is provided at a portion adjacent to the recessed portion in the width direction so as to extend inward in the base portion.

### CROSS-REFERENCE TO RELATED APPLICATION

This application claims priority to Japanese Patent Application No. 2020-065984 filed on Apr. 1, 2020, incorporated herein by reference in its entirety.

### BACKGROUND

### 1. Technical Field

The disclosure relates to a collector terminal, a battery, and a manufacturing method of the battery. More particularly, the disclosure relates to a structure of a collector terminal that electrically connects an external terminal attached to a battery case and an electrode body accommodated within the case, a battery provided with the collector terminal, and a manufacturing method of the battery provided with the collector terminal.

### 2. Description of Related Art

In recent years, research and development relating to various types of batteries are being vigorously pursued. Of these, the importance of secondary batteries such as lithium-ion batteries for onboard power sources, and power sources for personal computers, mobile terminals, and so forth, is increasing. In particular, lithium-ion batteries, which are lightweight and which yield high energy density, are preferably used as onboard high-output power sources.

Some lithium-ion batteries, for example, have a configuration in which an external terminal, at least part of which is disposed outside of a battery case, and an electrode body accommodated within the case, are electrically connected via a collector terminal (e.g., see Japanese Unexamined Patent Application Publication No. 2018-037253 (JP 2018-037253 A) and Japanese Unexamined Patent Application Publication No. 2016-081612 (JP 2016-081612 A)). The collector terminal has a base portion that is attached to the battery case (lid member, etc.), and a lead portion that is a portion extending from the base portion and connected to an electrode body, as described in these patent literatures. A boundary portion between these is bent and joined to each of the external terminal and the electrode body described above.

### SUMMARY

Now, in recent years, batteries have become commonplace, and in accordance therewith, there is demand for technology to assemble and mass-produce batteries more easily, and for higher output of batteries. One innovation made to facilitate assembly of batteries is to make the boundary portion of the base portion and the lead portion of a collector terminal as described above to be easily bendable. When the bending causes distortion of the collector terminal, attaching the collector terminal to an external terminal may be problematic. This is a factor that impedes easy assembly of batteries, and consequently impedes mass-production of batteries.

In order to appropriately accommodate the collector terminal within the battery case, bending of the collector terminal needs to be performed such that the lead portion is bent with part of the base portion on the outer side of a curvation. Now, the present inventor found that ease of bend-working can be improved by providing a start point of the bend on the inner side of the base portion. The present inventor further found that reducing the thickness of the collector terminal in a proximity of the start point as compared to the other portions enables occurrence of distortion from bending to be markedly reduced.

The disclosure provides technology that, with regard to a collector terminal of a battery, improves ease of bend-working of the collector terminal, and enables the battery to be easily assembled.

A first aspect of the disclosure relates to a collector terminal that electrically connects an external terminal at least part of which is disposed on an outer side of a battery case and an electrode body accommodated on an inner side of the battery case. The collector terminal includes a base portion that is attached to the external terminal, and a lead portion that extends from the base portion and is joined to the electrode body. A recessed portion is provided at a foot part of the lead portion at a boundary portion between the base portion and the lead portion so as to extend along a width direction orthogonal to an extending direction of the lead portion. A slit is provided at a portion adjacent to the recessed portion in the width direction so as to extend inward in the base portion.

According to the first aspect, the boundary portion between the base portion and the lead portion is a start point for bending. This improves ease of bend-working. Also, the thickness of the collector terminal at the recessed portion is smaller than the thickness of the collector terminal at a portion in the proximity of the recessed portion. Accordingly, distortion can be suppressed from occurring in the collector terminal by the bending. Suppressing occurrence of distortion in this way enables reduction in contact surface between the collector terminal and the external terminal to be suppressed. Accordingly, battery performance can be improved.

In the first aspect, a surface shape of the recessed portion may be arc-shaped in sectional view. According to this configuration, the surface of the recessed portion is readily curved by bending when performing the bend-working of the collector terminal. Also, the advantages of suppressed occurrence of distortion can be increased.

In the above aspect, a length of the slit in the extending direction may be no less than a thickness of the lead portion at a deepest part of the recessed portion. According to the above configuration, ease of bend-working of the collector terminal is improved even further.

In the above aspect, the thickness of the lead portion at a deepest part of the recessed portion may be no less than ½ and no more than ⅔ of the thickness of the lead portion at a portion in a proximity of the recessed portion. According to the above configuration, the advantages of improved ease in bend-working are manifested more suitably. Also, sufficient strength of the recessed portion can be secured. Further, increase in resistance of the battery can be suppressed.

In the above aspect, the lead portion may be configured to be bent with respect to the base portion with the boundary portion as a start point such that a surface of the recessed portion is on an outer side of a curvation when a battery is constructed.

In the above aspect, the base portion may be rectangular in shape.

A second aspect of the disclosure relates to a battery. The battery includes a battery case, an electrode body that is accommodated on an inner side of the battery case, and that includes a positive electrode and a negative electrode, external terminals at least part of which is disposed on an outer side of the battery case, and a positive-electrode collector terminal and a negative-electrode collector terminal that electrically connect the external terminals and the electrode body. At least one of the positive-electrode collector terminal and the negative-electrode collector terminal is the collector terminal according to the above first aspect. In the collector terminal, the lead portion is provided to be bent with respect to the base portion such that a surface of the recessed portion is on the outer side of a curvation.

A third aspect of the disclosure relates to a method of manufacturing the battery according to the second aspect. The method includes assembling the collector terminal and the external terminals, performing clinching working, joining the collector terminal to the electrode body, and accommodating the electrode body in the battery case. In the assembling of the collector terminal and the external terminals, the collector terminal is used in which the lead portion is bent with respect to the base portion with the boundary portion as a start point such that the surface of the recessed portion is on the outer side of the curvation.

According to the aspects of the disclosure, ease of bend-working of the collector terminal is improved. Accordingly, construction of a battery provided with such a collector terminal is easier as compared to conventional arrangements, and can easily be mass-produced. Also, a battery with good battery performance, in which increase of resistance is suitably suppressed, can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view schematically illustrating a structure of a battery including a collector terminal (collector terminal of positive electrode side) according to an embodiment;

FIG. 2 is a cross-sectional view of principal portions, schematically illustrating the proximity of a positive-electrode terminal structure of the battery in FIG. 1;

FIG. 3 is a perspective view schematically illustrating the structure of a positive-electrode collector terminal according to the embodiment, before bend-working;

FIG. 4 is a perspective view schematically illustrating the structure of the positive-electrode collector terminal according to the embodiment, after bend-working; and

FIG. 5 is a view taken along arrow A in an area indicated by a circle in FIG. 4.

### DETAILED DESCRIPTION OF EMBODIMENTS

An embodiment of the disclosure will be described below. Note that in the following drawings, members and parts that have the same effects are described denoted by the same signs. Also, dimensional relations (length, width, thickness, etc.) in the drawings do not reflect actual dimensional relations. Matters other than those stated in particular in the present specification but are matters necessary to carry out the disclosure can be understood to be matters of design of those skilled in the art based on the related art in this field. The notation “A to B” indicating a numerical value range in the present specification means no less than A and no more than B, and encompasses those exceeding A and below B. A collector terminal and a battery provided with the collector terminal disclosed here will be described below in detail by way of example of a rectangular lithium-ion battery that has a wound electrode body.

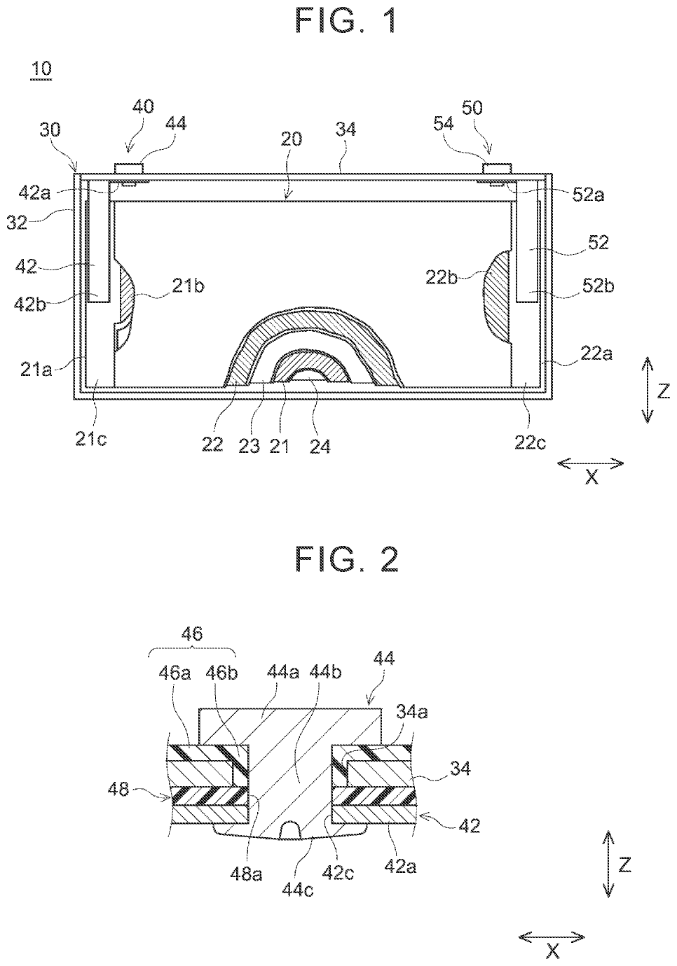

First, the configuration of the battery including the collector terminal disclosed here will be described with reference to FIG. 1. Note that in the present specification, the sign X in the drawings indicates the width direction of the battery, and the sign Z indicates the height direction of the battery. Note that these directions are directions set for the sake of convenience of description, and are not intended to limit the way in which the battery is installed.

As illustrated in FIG. 1, a battery 10 is provided with an electrode body 20, a battery case 30, a positive electrode terminal structure 40, and a negative electrode terminal structure 50. Each of the structures will be described below.

The electrode body 20 is an electricity generating element accommodated within the battery case 30 in a state covered by an insulating film (omitted from illustration) or the like. The electrode body 20 has a positive electrode 21 in a form of a slender sheet, a negative electrode 22 in a form of a slender sheet, and separators 23 and 24 in forms of slender sheets. This electrode body 20 is a wound electrode body in which the aforementioned members in forms of slender sheets are wound around themselves. Note that the structure of the electrode body 20 is not restricted in particular, and various structures employed in conventional general secondary batteries (e.g., lithium-ion batteries) can be employed without limitation. For example, the electrode body 20 may be a laminated electrode body in which rectangular strips of sheet-like positive and negative electrodes are laminated with separators interposed therebetween.

The positive electrode 21 is provided with a foil-like positive-electrode collector 21a (e.g., aluminum foil) and a positive-electrode active material layer 21b provided on a surface of the positive-electrode collector 21a (preferably both faces). Also, a positive-electrode connection portion 21c where the positive-electrode active material layer 21b is not provided and the positive-electrode collector 21a is exposed is provided at one edge-end portion in the width direction X of the positive electrode 21 (at the left-side edge-end portion in FIG. 1). Note that various materials are included in the positive-electrode active material layer 21b, such as positive-electrode active material, binder, electroconductive material, and so forth. Materials included in this positive-electrode active material layer 21b are not restricted in particular. Various materials employed in conventional general secondary batteries (e.g., lithium-ion batteries) can be used without limitation, and these will be omitted from detailed description as they do not limit the disclosure.

The negative electrode 22 is provided with a foil-like negative-electrode collector 22a (e.g., copper foil) and a negative-electrode active material layer 22b provided on a surface of the negative-electrode collector 22a (preferably both faces). Also, a negative-electrode connection portion 22c where the negative-electrode active material layer 22b is not provided and the negative-electrode collector 22a is exposed is provided at another edge-end portion in the width direction X of the negative electrode 22 (at the right-side edge-end portion in FIG. 1). Various materials are included in the negative-electrode active material layer 22b, in the same way as in the positive-electrode active material layer 21b, such as negative-electrode active material, binder, and so forth. Materials included in this negative-electrode active material layer 22b are not restricted in particular either. Various materials employed in conventional general secondary batteries can be used without limitation, and these will be omitted from detailed description as they do not limit the disclosure.

The separators 23 and 24 are interposed between the positive electrode 21 and the negative electrode 22, suppressing direct contact between these electrodes. Although omitted from illustration, the separators 23 and 24 have a plurality of fine pores, and are configured enabling charge carriers (lithium ions when a lithium-ion battery) to travel between the positive electrode 21 and the negative electrode 22 through these fine pores. Resin sheets or the like having predetermined heat resistance are used as the separators 23 and 24, but those employed in conventional general secondary batteries can be used without limitation, and accordingly these will be omitted from detailed description.

The battery case 30 is a container that accommodates the electrode body 20. The battery case 30 is a flat rectangular container, and is provided with a rectangular case main body 32 of which the upper face is opened, and a plate-like lid member 34 that closes off the opening of the case main body 32, as illustrated in FIG. 1. A metal material that has a predetermined strength (e.g., aluminum, aluminum alloy, stainless steel, etc.) may be used for the battery case 30.

The battery 10 has a positive-side electrode terminal structure (positive electrode terminal structure 40) and a negative-side electrode terminal structure (negative electrode terminal structure 50) disposed at respective end portions of the lid member 34, in the sideways direction (X direction in FIG. 1) of the lid member 34.

The positive electrode terminal structure 40 is provided with a positive-electrode external terminal 44 and a positive-electrode collector terminal 42. The positive-electrode external terminal 44 is disposed on the outer portion of the battery case 30, as illustrated in FIG. 1. A part of the positive-electrode external terminal 44 reaches the inner portion of the battery case 30 from the outer portion thereof, and is connected to the positive-electrode collector terminal 42. The positive-electrode collector terminal 42 is disposed inside the battery case 30. The positive-electrode collector terminal 42 is connected to the positive-electrode external terminal 44 as described above. The positive-electrode collector terminal 42 also is connected to the positive electrode 21 (positive-electrode connection portion 21c) of the electrode body 20. Note that in the battery 10, both of the positive-electrode collector terminal 42 and the positive-electrode external terminal 44 may be configured of a metal material of which aluminum is the primary component. Thus, the positive-electrode collector terminal 42 and the positive-electrode external terminal 44 may be configured of the same metal material (similar-metal material), but this is not limiting in particular, and may be configured of the different metal materials (dissimilar-metal materials). Metal materials usable for the positive-electrode collector terminal 42 and the positive-electrode external terminal 44 can be used without limitation.

The negative electrode terminal structure 50 is provided with a negative-electrode external terminal 54 and a negative-electrode collector terminal 52. The negative-electrode external terminal 54 is disposed on the outer portion of the battery case 30, as illustrated in FIG. 1. A part of the negative-electrode external terminal 54 reaches the inner portion of the battery case 30 from the outer portion thereof, and is connected to the negative-electrode collector terminal 52. The negative-electrode collector terminal 52 is disposed inside the battery case 30. The negative-electrode collector terminal 52 is connected to the negative-electrode external terminal 54 as described above. The negative-electrode collector terminal 52 also is connected to the negative electrode 22 (negative-electrode connection portion 22c) of the electrode body 20. Note that in the negative electrode terminal structure 50, the negative-electrode collector terminal 52 may be configured of a metal material of which copper is the primary component, unlike the above-described positive electrode terminal structure 40, and the negative-electrode external terminal 54 may be configured of a metal material of which aluminum is the primary component. Thus, the negative-electrode collector terminal 52 and the negative-electrode external terminal 54 are configured of different metal materials (dissimilar-metal materials), but this is not limiting in particular, and may be configured of the same metal material (similar-metal material). Metal materials usable for the negative-electrode collector terminal 52 and the negative-electrode external terminal 54 can be used without limitation in particular.

The above electrode terminal structure will be described in further detail. The positive electrode terminal structure 40 and the negative electrode terminal structure 50 in the battery 10 are disposed substantially symmetrically across the center in the above X direction as an axis of symmetry. Accordingly, description will be made below in detail regarding the configuration of the positive electrode terminal structure 40, with reference to FIG. 2. Description regarding the configuration of the negative electrode terminal structure 50 is the same as that of the positive-electrode side, and accordingly description thereof will be omitted.

The positive-electrode external terminal 44 is provided with a basal portion 44a, a shaft portion 44b, and a distal end portion 44c. The shaft portion 44b extends from the basal portion 44a, substantially perpendicular to the inner side of the battery case 30, passes through a through hole defined by a cylindrical portion 46b, a terminal attachment hole 34a, and a through hole 42c. The distal end portion 44c is clinched, thereby forming a clinched portion. That is to say, part of the positive-electrode external terminal 44 is disposed on the inner side of the battery case 30. The basal portion 44a is disposed on the outer side of the battery case 30, along the lid member 34. The basal portion 44a has a plate-like form, and may be, for example, rectangular in shape (including substantially rectangular shapes) or circular in shape (including elliptical shapes).

A first insulating member 46 is disposed between the positive-electrode external terminal 44 and the lid member 34, as illustrated in FIG. 2. The first insulating member 46 is provided with a basal portion 46a and the cylindrical portion 46b. The cylindrical portion 46b defines a through hole. The shape and the size of this through hole are not limited in particular, as long as the positive-electrode external terminal 44 is inserted therethrough and a clinched portion that has sufficient airtightness is formed. The first insulating member 46 is configured of a material having insulating properties, examples of which include polyolefins such as polypropylene (PP), polyethylene (PE), and so forth, and resin materials such as polyphenylene sulfide resin (PPS) and so forth.

The battery case 30 (lid member 34) has the terminal attachment hole 34a through which the shaft portion 44b of the positive-electrode external terminal 44 is inserted, extending from the outer face of the battery case 30 to the inner face thereof. The shape and the size of the terminal attachment hole 34a are not limited in particular, as long as the positive-electrode external terminal 44 and the cylindrical portion 46b are inserted therethrough and a clinched portion that has sufficient airtightness is formed.

A second insulating member 48 is disposed between the lid member 34 and the positive-electrode collector terminal 42, as illustrated in FIG. 2. The second insulating member 48 has a through hole 48a through which the shaft portion 44b of the positive-electrode external terminal 44 is inserted. The shape and the size of this through hole are not limited in particular, as long as the positive-electrode external terminal 44 is inserted therethrough and a clinched portion that has sufficient airtightness is formed. The second insulating member 48 is configured of a material having elasticity, insulating properties, and electrolyte resistance. Example of this material include fluororesins such as a tetrafluoroethylene/perfluoro (alkyl vinyl ether) copolymer (PFA) and so forth.

The positive-electrode collector terminal 42 is a member that electrically connects the positive-electrode external terminal 44 and the electrode body 20, and is provided with a base portion 42a and a lead portion 42b (see FIG. 1). The through hole 42c through which the shaft portion 44b of the positive-electrode external terminal 44 passes is provided in the base portion 42a. The base portion 42a is disposed along the inner face of the lid member 34. The lead portion 42b extends substantially perpendicular from the base portion 42a to the inside of the battery case 30, and the distal end portion thereof is joined to the positive electrode (positive-electrode connection portion) of the electrode body 20. The shape and the size of the through hole 42c are not limited in particular, as long as the positive-electrode external terminal 44 is inserted therethrough and a clinched portion that has sufficient airtightness is formed.

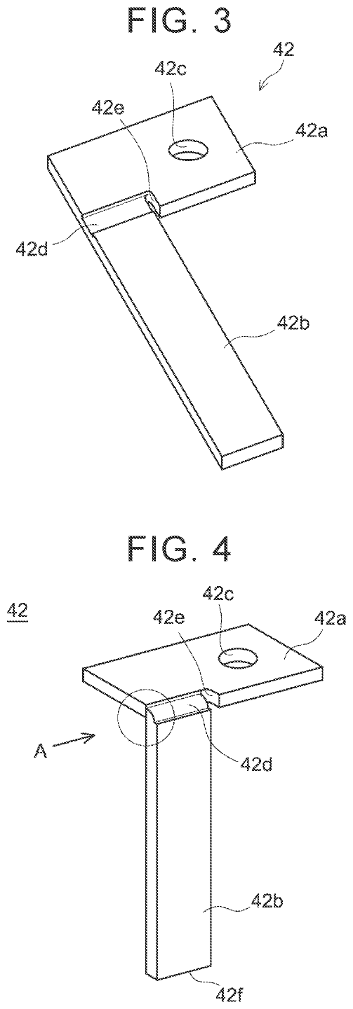

Next, the structure of the positive-electrode collector terminal 42 will be described with reference to FIGS. 3 and 4. In the positive-electrode collector terminal 42, a recessed portion 42d is provided at the foot part of the lead portion 42b at the boundary portion between the base portion 42a and the lead portion 42b, so as to extend along a width direction orthogonal to the extending direction of the lead portion 42b. A slit 42e is provided at a portion adjacent to the recessed portion 42d in this width direction, so as to extend inward in the base portion 42a. At least part of the recessed portion 42d is provided on the inner side of the base portion 42a, as illustrated in FIGS. 3 and 4. Note that in the present embodiment, “extending direction of the lead portion 42b” and “extending direction of the lead portion” mean the extending direction of the lead portion (42b) at the collector terminal prior to the bend-working. It can be confirmed from FIG. 3 that this direction is the same direction as the direction of the short sides of the base portion 42a.

When a battery is constructed, a collector terminal having a base portion and a lead portion is bent (typically a 90° bend) with the boundary portion between the base portion and the lead portion as the start point of the bend. When this start point of the bend is provided at the inner side of the base portion, distortion may readily occur in a region in the proximity of this boundary portion in association with the bending. Conversely, in the present embodiment, the recessed portion 42d and the slit 42e as described above are provided in the positive-electrode collector terminal 42, thereby providing the start point of the bend-working at the boundary portion of the base portion 42a and the lead portion 42b. The lead portion 42b is bent with respect to the base portion 42a in the positive-electrode collector terminal 42 such that the surface of the recessed portion 42d is on the outer side of the curvation when the battery is constructed. Accordingly ease of the bend-working of the positive-electrode collector terminal 42 is improved. Also, when bending the collector terminal, distortion due to the bending readily occurs at the proximity of the start point of the bend (e.g., the surface on the inner side of the curvation). This is undesirable, since the area of contact between the collector terminal and the external terminal is reduced, which can become a factor in reducing performance of the battery. Conversely, with the positive-electrode collector terminal 42 in the present embodiment, the recessed portion 42d that has a smaller thickness than other portions is provided in the proximity of the start point of the bend. Accordingly, occurrence of this distortion can be suppressed.

The shape of the recessed portion 42d is not limited in particular. For example, the shape of the surface of the recessed portion 42d may be configured to have a rectangular shape when viewed in cross section. Alternatively, the shape of the surface of the recessed portion 42d may be configured to have an arc shape when viewed in cross section. The term “arc shape” is not limited to part of a true circle, and may be part of an ellipse, or may be a letter-U shape. The shape of the surface of the recessed portion 42d preferably is an arc shape when viewed in cross section, from the perspective of ease of working. The recessed portion 42d is preferably a groove having a U-shape. Also, the shape of the recessed portion 42d in cross-sectional view may be a tapered shape where the width of the recessed portion 42d becomes narrower toward the deepest portion of the recessed portion 42d.

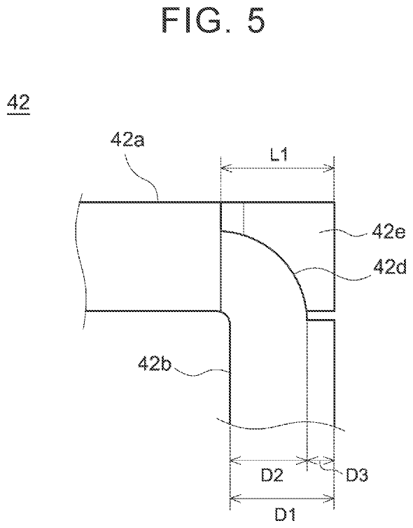

Also, when the recessed portion 42d and the slit 42e are made to have a predetermined dimensional relation in the positive-electrode collector terminal 42, ease of the bend-working can be improved even further. This dimensional relation will be described below with reference to FIG. 5. FIG. 5 is a view taken along arrow A in an area indicated by a circle in FIG. 4. In FIG. 5, D1 represents the thickness of the positive-electrode collector terminal 42. In other words, D1 represents the thickness of the base portion 42a as well, and the thickness of the lead portion 42b as well. D2 represents the thickness of the lead portion 42b at the deepest portion of the recessed portion 42d. D3 represents the depth of the recessed portion 42d, and is the depth from the surface of the positive-electrode collector terminal 42 (lead portion 42b) to the deepest portion of the recessed portion 42d. L1 represents the length of the slit 42e. Note that the length L1 of the slit 42e is the length of the slit 42e in the extending direction of the lead portion 42b.

The thickness D2 of the lead portion 42b at the deepest portion of the recessed portion 42d preferably is a thickness no more than ⅔ of the thickness D1 of the positive-electrode collector terminal 42 (i.e., the thickness of the lead portion 42b at the proximity of the recessed portion 42d). When the thickness D2 is within this range, ease of working of the positive-electrode collector terminal 42 can be improved. On the other hand, in order to secure sufficient strength of the positive-electrode collector terminal 42, the thickness D2 preferably is no less than ½ of the thickness D1. In other words, from the perspective of ease of working, the depth D3 of the recessed portion 42d preferably is a depth that is no less than ⅓ of the thickness D1. On the other hand, in order to secure sufficient strength of the positive-electrode collector terminal 42, the depth preferably is no less than ½ of the thickness D1. The thickness D1 may be in a range of 0.5 mm to 2.5 mm, although not limited in particular. The recessed portion 42d is designed to satisfy the above range in such a positive-electrode collector terminal.

The length of the recessed portion 42d in the extending direction of the lead portion 42b is not limited in particular. This length may be the same length as the later-described length L1 of the slit 42e, or may be a different length. When this length is different from the length L1 of the slit 42e, the length of the recessed portion 42d may be longer than or shorter than the length L1 of the slit 42e. From the perspective of suppressing increase in resistance, the length of the recessed portion 42d preferably is longer than or around the same as the length L1 of the slit 42e.

The length L1 of the slit 42e in the above extending direction is no less than the thickness D2 of the positive-electrode collector terminal 42 at the deepest portion of the recessed portion 42d, from the perspective of ease of working. To manifest the advantages of the disclosure well, normalizing the thickness D2 to 1, the length L1 preferably is no less than 1.2 and no more than 1.6. The width of the slit 42e is not limited in particular. In order to suppress increase in resistance, this width preferably is smaller than 1 mm (e.g., more than 0 mm but no more than 0.5 mm).

Although not limiting in particular, an example of a suitable dimensional relation among the base portion 42a, the lead portion 42b, the recessed portion 42d, and the slit 42e in the positive-electrode collector terminal 42 will be shown below. For example, when the long sides of the base portion 42a are around 20 mm (e.g., no less than 17 mm and no more than 23 mm), the short sides of the base portion 42a are around 10 mm (e.g., no less than 8 mm and no more than 12 mm), and the width of the lead portion 42b is around 6 mm (e.g., no less than 5 mm and no more than 7 mm), and when normalizing the length of the long sides of the base portion 42a to 1, the width of the recessed portion 42d may be no less than 0.25 and no more than 0.35. When normalizing the length of the short sides of the base portion 42a to 1, the width of the recessed portion 42d may be no less than 0.60 and no more than 0.70. When normalizing the thickness D1 of the base portion 42a to 1, the width of the recessed portion 42d may be no less than 3.0 and no more than 4.0.

The length of the recessed portion 42d in the extending direction of the lead portion 42b may be no less than 1.5 mm and smaller than 2.5 mm. When normalizing the length of the long sides of the base portion 42a to 1, this length of the recessed portion 42d may be no less than 0.082 and smaller than 0.14. When normalizing the length of the short sides of the base portion 42a to 1, this length of the recessed portion 42d may be no less than 0.16 and smaller than 0.27. When normalizing the thickness D1 of the base portion 42a to 1, this length of the recessed portion 42d may be no less than 0.94 and smaller than 1.56.

The depth D3 of the recessed portion 42d may be larger than 0 mm and no more than 0.6 mm. When normalizing the length of the long sides of the base portion 42a to 1, the depth D3 of the recessed portion 42d may be larger than 0 and no more than 0.032. When normalizing the length of the short sides of the base portion 42a to 1, the depth D3 of the recessed portion 42d may be larger than 0 and no more than 0.065. When normalizing the thickness D1 of the base portion 42a to 1, the depth D3 of the recessed portion 42d may be larger than 0 and no more than 0.37 (e.g., no more than 0.3).

Next, a manufacturing method of a battery to which the above collector terminal is to be applied will be described. The signs below are the signs shown in FIGS. 1 and 2. Generally speaking, this manufacturing method includes assembling the collector terminal and the external terminal and performing clinching, joining the collector terminal to the electrode body, and accommodating the electrode body in the battery case.

In the assembling of the collector terminal and the external terminal, the shaft portion 44b of the positive-electrode external terminal 44 is inserted through the cylindrical portion 46b of the first insulating member 46, the terminal attachment hole 34a of the lid member 34, the through hole 48a of the second insulating member 48, and the through hole 42c of the positive-electrode collector terminal 42, in this order. The positive-electrode collector terminal 42 in which the lead portion 42b is in a bent state with respect to the base portion 42a, such that the surface of the recessed portion 42d is on the outer side of the curvation, is used here. Next, the basal portion 44a of the positive-electrode external terminal 44 and the base portion 42a of the positive-electrode collector terminal 42 are clamped by a pair of pressurizing portions of a press apparatus (omitted from illustration), and pressed toward each other. The distal end portion 44c of the positive-electrode external terminal 44 that protrudes from the through hole 42c is then abutted by a clinching member (omitted from illustration), and the distal end portion 44c is crushed, thereby forming a clinched portion.

Next, the positive-electrode collector terminal 42 (lead portion 42b) is joined to the electrode body 20 fabricated by a conventionally-known method. The method of joining the positive-electrode collector terminal 42 to the electrode body 20 is not limited in particular, and joining means appropriate for the material of the electrode body and the collector terminal may be used. Examples of the joining means include conventionally-known welding means, such as ultrasonic welding, resistance welding, laser beam welding, and so forth. A clinched portion is formed by the same method described above for the negative electrode as well, and the negative-electrode collector terminal 52 and the electrode body 20 are joined. The electrode body 20 is then accommodated in the battery case 30, and the lid member 34 is welded on. The battery case 30 is filled with an electrolytic solution, and the opening of the battery case is sealed off. Initial activation and aging processing are performed under predetermined conditions, thereby constructing a battery 10 that is in a usable state.

Note that although the above-described battery is provided with the collector terminal described herein as the positive-electrode collector terminal and the negative-electrode collector terminal, this is not limiting. That is to say, an arrangement in which at least one of the positive-electrode collector terminal and the negative-electrode collector terminal of the battery disclosed here has the structure of this collector terminal is sufficient, and a collector terminal of a different structure from this collector terminal may be included.

According to the disclosure, a recessed portion is provided at the foot part of the lead portion, at the boundary portion between the base portion and the lead portion of the collector terminal, so as to extend along the width direction of the lead portion, as described above. A slit is also provided at a portion adjacent to the recessed portion in the same direction, so as to extend inward in the base portion. In the collector terminal having such a configuration, a portion serving as the start point for the bend-working is provided, improving ease of the bend-working. The thickness of the recessed portion is configured to be relatively small in the collector terminal, and accordingly distortion due to bending does not readily occur. Also, the ease of the bend-working can be further improved by the recessed portion and the slit having predetermined shapes. Further, increase in resistance can be suppressed.

Further, improved ease in the bend-working of the collector terminal improves ease of assembly of batteries having such collector terminals as compared to conventional arrangements. Also, increase in resistance is suppressed as described above, and accordingly increase in resistance is suitably suppressed in batteries provided with the collector terminal disclosed here as a collector terminal.

Specific test examples relating to the disclosure are described below. These test examples are not intended to limit the disclosure.

### Test Example 1: Evaluation of Resistance Value

In Test Example 1, three samples with different depths in the collector terminal were designed. The samples were analyzed by computer-aided engineering (CAE), and resistance values were evaluated.

### Sample 1

An aluminum collector terminal model of the form illustrated in FIG. 4 was designed as Sample 1. The overview of Sample 1 is as follows.

Material: Aluminum (A1050-H24)
Density: 2.7×10⁻⁹ (tonne/mm³)
Electric conductivity: 225 (S/m)

Thickness D1: 1.6 mm

Recessed portion: arc-shaped
Depth D3: 0.2 mm

Base portion:
Long sides: 18.2 mm
Short sides: 9.2 mm

Lead portion:
Width: 6.0 mm

Slit:
L1: 1.5 mm

### Sample 2

A collector terminal according to Sample 2 was designed in the same way as with Sample 1, except that the depth D3 was 0.4 mm.

### Comparative Sample 1

A collector terminal according to Comparative Sample 1 was designed in the same way as with Sample 1, except that neither the recessed portion nor the slit was provided.

The above Samples and Comparative Sample were subjected to bend-working to a bend angle of 90° , and electric current values were analyzed at the position indicated by sign 42c, with the voltage at the position indicated by sign 42f set to 0 V and the voltage at the position indicated by sign 42c set to 0.1 V, in FIG. 4. The current values obtained here, and the voltage (0.1 V) at this position, were used to calculate the resistance values of the Samples and Comparative Sample.

When normalizing the resistance value of Comparative Sample 1 to 100, the resistance value of Sample 1 was around 99, and the resistance value of Sample 2 was around 98. That is to say, providing the recessed portion and the slit of the predetermined shapes in the collector terminal was found to lower the resistance value as compared to the collector terminal in which neither the recessed portion nor the slit was provided. Also, the deeper the recessed portion was, the smaller the resistance value was found to be. Thus, providing the recessed portion at the boundary portion between the base portion and the lead portion, along the width direction of the lead portion, and providing the slit extending inward in the base portion at a portion adjacent to the recessed portion was found to enable the resistance value of the collector terminal to be reduced. Also, increase in battery resistance was found to be suppressed in a battery provided with an arrangement where a collector terminal has been subjected to bend-working in this way.

Although a specific example of the disclosure has been described in detail, this is only exemplary, and does not limit the Claims. The technology set forth in the Claims includes various modifications and changes made to the specific example exemplified above. For example, although a battery having the collector terminal disclosed here as a collector terminal is described as being a lithium-ion battery, this is not limiting, and this battery may be a sodium-ion battery, a magnesium battery, or a nickel-metal hydride battery.

What is claimed is:

1. A collector terminal that electrically connects an external terminal at least part of which is disposed on an outer side of a battery case and an electrode body accommodated on an inner side of the battery case, the collector terminal comprising:
a base portion that is attached to the external terminal; and
a lead portion that extends from the base portion and is joined to the electrode body, wherein:
a recessed portion is provided at a foot part of the lead portion at a boundary portion between the base portion and the lead portion so as to extend along a width direction orthogonal to an extending direction of the lead portion; and
a slit is provided at a portion adjacent to the recessed portion in the width direction so as to extend inward in the base portion.

2. The collector terminal according to claim 1, wherein a surface shape of the recessed portion is arc-shaped in sectional view.

3. The collector terminal according to claim 1, wherein a length of the slit in the extending direction is no less than a thickness of the lead portion at a deepest part of the recessed portion.

4. The collector terminal according to claim 1, wherein a thickness of the lead portion at a deepest part of the recessed portion is no less than ½ and no more than ⅔ of a thickness of the lead portion at a portion in a proximity of the recessed portion.

5. The collector terminal according to claim 1, wherein the lead portion is configured to be bent with respect to the base portion with the boundary portion as a start point such that a surface of the recessed portion is on an outer side of a curvation when a battery is constructed.

6. The collector terminal according to claim 1, wherein the base portion is rectangular in shape.

7. A battery comprising:
a battery case;
an electrode body that is accommodated on an inner side of the battery case, and that includes a positive electrode and a negative electrode;
external terminals at least part of which is disposed on an outer side of the battery case; and
a positive-electrode collector terminal and a negative-electrode collector terminal that electrically connect the external terminals and the electrode body, wherein:
at least one of the positive-electrode collector terminal and the negative-electrode collector terminal is the collector terminal according to claim 1; and
in the collector terminal, the lead portion is provided to be bent with respect to the base portion such that a surface of the recessed portion is on an outer side of a curvation.

8. A method of manufacturing the battery according to claim 7, the method comprising:
assembling the collector terminal and the external terminals;
performing clinching working;
joining the collector terminal to the electrode body; and
accommodating the electrode body in the battery case, wherein in the assembling of the collector terminal and the external terminals, the collector terminal is used in which the lead portion is bent with respect to the base portion with the boundary portion as a start point such that the surface of the recessed portion is on the outer side of the curvation.
